(19) United States
(12) Patent Application Publication
(10) Pub. No.: US 2006/0282442 A1
(43) Pub. Date: Dec. 14, 2006

(54) Method of learning associations between documents and data sets

(75) Inventors: Alison Joan Lennon, Balmain (AU); Khanh Phi Van Doan, Noranda (AU); Joe Mariadassou, Baulkham Hills (AU)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/407,238

(22) Filed: Apr. 20, 2006

(30) Foreign Application Priority Data
Apr. 27, 2005 (AU) 2005201758

(51) Int. Cl. G06F 7/00; G06F 17/30; G06F 17/00

(52) U.S. Cl. 707/100; 707/3; 715/500

(57) ABSTRACT

A method of learning associations between classes of documents and one or more structured data sets comprises a step of classifying an input document into a class selected from a predefined set of classes (step 115). One or more structured data sets are displayed (step 130), wherein the displayed structured data sets are dependent on association information for the class. One or more indications of changes to the displayed structured data sets are received (steps 815, 830, 845) and the association information for the class is amended (step 850) based on the received indications.

### CROSS-REFERENCE TO RELATED PATENT APPLICATIONS

This application claims the right of priority under 35 U.S.C. § 119 based on Australian Patent Application No. 2005201758, filed 27 Apr. 2005, which is incorporated by reference herein in its entirety as if fully set forth herein.

### FIELD OF THE INVENTION

The present invention relates to the extraction of data from documents, such as letters or memos. In particular, the present invention relates to learning associations between structured data sets (in existing databases) and documents, the structured data sets containing information required to process the documents.

### BACKGROUND

Office environments receive large amounts of information from customers and/or business partners in the form of letters, faxes, memos and emails. This correspondence is generally very unstructured in that the layout and content of the document vary for each document pertaining to a particular task (e.g., changing the address for a bank account). Generally, information needs to be extracted from these documents to be entered into corporate databases and workflow systems. In the cases where the information is contained in physical documents, the documents are typically scanned and then submitted for electronic processing. However, the processing of these documents is very time consuming because an operator must generally read the document and often re-key data from the document into an appropriate computer software application.

Clearly, in order to avoid the work associated with processing these unstructured documents, it is advantageous for a company to either provide internet services or make available standard forms for customers and business partners to use. In many cases, internet services can result in requests or notifications from customers or business partners being processed almost entirely automatically by a computer software application. In other words, the need for operators, and thus the cost to the company, is reduced substantially. However, this method requires that all customers and business partners have access to the internet services. In addition, there are many requests and/or notifications that must be signed by the customer or business partner and verified by the receiving company. Although there is considerable progress in the area of electronic signature verification, this technology is still not sufficiently well tested in the corporate workplace to be adopted by many players.

If a company can make standard forms available, then these forms can be completed by the customers and business partners and returned to the company for processing. Standard forms are much easier to process than unstructured documents because the form defines exactly where all the completed data is. Also the company can ensure that all the data that is required to process the request or notification is on the form. In other words, if the customer or business partner completes all required fields of the form, there will be no missing data, and therefore no need to involve an operator to complete the necessary information.

There are many software applications that enable the processing of scanned completed forms and extraction of data from the forms. These applications (e.g., Teleforms from Cardiff Software, Inc.) typically work by an operator (or system administrator) defining the exact location and type of data expected for each of the fields of a form, from which data is to be extracted. The forms-processing software can then recognise a scanned document from the pattern of the fields and extract the necessary data using optical character recognition (OCR) technology. In some cases the confidence level of the OCR for a data field may be low due to poorly legible writing by the customer or business partner. In these cases, the software application may extract what data it can and then require an operator to either correct or confirm the extracted data. Other forms recognition software applications may require the operator to confirm all extracted data.

Even so, this task is far less onerous for the operator than either re-keying all the necessary data from an image of the document or using copy and paste techniques to transfer data from the scanned document to an electronic form for subsequent processing.

Often it is possible to specify database conditions for fields of a form when the form is being defined. These database conditions may be used to validate that extracted data is valid (e.g., valid account codes for a bank). Alternatively, they can be used to obtain information related to extracted fields (e.g., the name of bank branch using the bank branch code). These database conditions are used when the form is processed to either validate or complete extra information before the request or notification is processed. An operator may be alerted if invalid codes are detected or account names do not correspond to account codes. Once again, the operator needs to correct these errors before the form's processing is complete.

Unfortunately, standard forms (and hence forms recognition) cannot always be used because a company often does not have control over the format of incoming requests or notifications. For example, invoices are typically generated by the charging business's own software applications. Therefore, each company will receive many different formats for invoices because all their customers and business partners do not use the same software application. It is often not practical to define each invoice form that could possibly be received by a company as a separate form in a forms recognition software package.

The use of standard forms is also not possible when customers or business partners do not have easy access to a company's forms. For example, if a customer wanted to change some of the details associated with a bank account, the customer will generally not want to visit the local bank branch to obtain the form. Forms can be made available over the internet, but there are many people who either do not have access to the internet, are not aware of how to obtain the necessary forms or do not have a printer to print out the form to complete.

Consequently, companies still receive many documents without the opportunity to control the structure and content of the received document. The companies thus cannot define exactly where the information to be extracted for subsequent processing is located. There are generally two classes of such documents: (i) those, referred to as “semi-structured”, which contain detectable elements of structure, such as tables; and (ii) those, referred to as “unstructured”, which do not contain any readily detectable elements of structure.

In the case of semi-structured documents, there exist software solutions that can process and extract data from these documents (e.g., the eFlow Platform from Top Image Systems of Tel Aviv, Israel, and eFirst from BancTec, Inc.). In many cases these applications rely on the fact that the documents for a particular purpose (e.g., invoices) contain the same type of data (e.g., invoice date and number, account number, purchase order number, ‘ship to’ information, order line items, and totals) and actively seek this information in the document.

Most semi-structured document processing engines use dynamic template libraries that accelerate the process of identifying forms and locating their data elements. Dynamic form templates do not define data element regions by exact pixel location in the way templates used by forms recognition software do. Instead, they are typically defined as a number of form regions and use rules based on topological structures or text elements to detect the defined form regions in actual documents. During application setup, dynamic templates that describe the form regions contained on the different form types can be set up. At process time, the processing engine attempts to match a document to one of the dynamic templates. If a successful match is found then data fields can be extracted from detected forms regions using either pixel information or OCR information that can be obtained for the document. Some applications use a scripting language to guide the software in searching for and locating data fields in each detected form region. In many cases the matching process makes use of the presence of detectable features such as tables to help locate data regions. Without such features it is difficult to define dynamic templates for many classes of documents.

If the variations between the semi-structured document and the nearest matching template are too significant, then the document can be stored as either as a new or variant template. In this way applications (e.g., the eFlow Freedom module from Top Image Systems, eFirst Forms+ from BancTec) can learn to recognise new types of semi-structured documents.

For unstructured documents, it is not possible to detect required extractable data using dynamic templates because the required data can be anywhere in the document and often there are no definable form regions. The classification of documents into various categories usually depends more on the content of the document rather than any overall layout. In this case, the document's content must be examined more closely, often including a semantic analysis of text within the document. In many cases, this is difficult to achieve reliably and companies must rely on operators to read each individual document and re-key the information necessary to process the request or notification.

Another problem that arises with unstructured documents is that generally the customer or business partner has constructed the document without knowledge of what data the company really needs to process their request or notification. This means that data is often missing. For example, a customer may include a bank account code but completely forget to include the bank branch code. This means that the operator processing the letter has to bring up views from the company's databases in order to identify the correct account based on customer name and account code.

In another example, a customer wanting to stop payment on a cheque may completely forget to include their cheque account code in their letter. Missing data like this makes it even more laborious for the operator to process the request or notification.

Another example of unstructured documents is emails. Customers who may have internet access may prefer to make requests to or notify a company using email. It may be much easier for customers to send an email to their bank or insurance company, rather than to find the correct form or web service (if available). In many ways, emails can be less structured than letters and memos, because they are generally composed and sent with little care taken with formatting and appearance. For this reason, emails also often contain incomplete information.

### SUMMARY OF THE INVENTION

It is an object of the present invention to substantially overcome, or at least ameliorate, one or more disadvantages of existing arrangements.

According to a first aspect of the invention there is provided a method of learning associations between classes of documents and one or more structured data sets, said method comprising the steps of:

classifying a document into a class selected from a predefined set of classes;

displaying one or more structured data sets, wherein the displayed structured data sets are dependent on association information for the class;

receiving one or more indications of changes to the displayed structured data sets; and

amending the association information for the class based on the received indications.

According to a second aspect of the invention there is provided a method of extracting information for processing a document; the method comprising the steps of:

classifying the document into a class selected from a predefined set of classes, wherein said classifying is dependent on first information in the document;

identifying a data set based on second information in the document, wherein said identifying is dependent on association information adaptively obtained through processing other documents in the class;

extracting data from the document and the data set to process the document according to one or more tasks associated with the class.

According to a third aspect of the invention there is provided a method of verifying information for processing a document, the method comprising the steps of:

classifying the document into a class selected from a predefined set of classes, wherein said classifying is dependent on first information in the document;

identifying a data set based on second information in the document, wherein said identifying is dependent on association information adaptively obtained through processing other documents in the class;

verifying information in the document using the identified data set;

extracting information from the document to process the document according to one or more tasks associated with the class.

According to a further aspect of the invention there is provided an apparatus for learning associations between classes of documents and one or more structured data sets, said apparatus comprising:

means for classifying a document into a class selected from a predefined set of classes;

means for displaying one or more structured data sets, wherein the displayed structured data sets are dependent on association information for the class;

means for receiving one or more indications of changes to the displayed structured data sets; and

means for amending the association information for the class based on the received indications.

According to a further aspect of the invention there is provided an apparatus for extracting information for processing a document, said apparatus comprising:

means for classifying the document into a class selected from a predefined set of classes, wherein said classifying is dependent on first information in the document;

means for identifying a data set based on second information in the document, wherein said identifying is dependent on association information adaptively obtained through processing other documents in the class;

means for extracting data from the document and the data set to process the document according to one or more tasks associated with the class.

According to a further aspect of the invention there is provided an apparatus for verifying information for processing a document, the apparatus comprising:

means for classifying the document into a class selected from a predefined set of classes, wherein said classifying is dependent on first information in the document;

means for identifying a data set based on second information in the document, wherein said identifying is dependent on association information adaptively obtained through processing other documents in the class;

means for verifying information in the document using the identified data set;

means for extracting information from the document to process the document according to one or more tasks associated with the class.

According to a further aspect of the invention there is provided a computer program product comprising machine-readable program code recorded on a machine-readable recording medium, for controlling the operation of a data processing apparatus on which the program code executes to perform a method of learning associations between classes of documents and one or more structured data sets, said method comprising the steps of:

classifying a document into a class selected from a predefined set of classes;

displaying one or more structured data sets, wherein the displayed structured data sets are dependent on association information for the class;

receiving one or more indications of changes to the displayed structured data sets; and

amending the association information for the class based on the received indications.

According to a further aspect of the invention there is provided a computer program product comprising machine-readable program code recorded on a machine-readable recording medium, for controlling the operation of a data processing apparatus on which the program code executes to perform a method of extracting information for processing a document; the method comprising the steps of:

classifying the document into a class selected from a predefined set of classes, wherein said classifying is dependent on first information in the document;

identifying a data set based on second information in the document, wherein said identifying is dependent on association information adaptively obtained through processing other documents in the class;

extracting data from the document and the data set to process the document according to one or more tasks associated with the class.

According to a further aspect of the invention there is provided a computer program product comprising machine-readable program code recorded on a machine-readable recording medium, for controlling the operation of a data processing apparatus on which the program code executes to perform a method of verifying information for processing a document, the method comprising the steps of:

classifying the document into a class selected from a predefined set of classes, wherein said classifying is dependent on first information in the document;

identifying a data set based on second information in the document, wherein said identifying is dependent on association information adaptively obtained through processing other documents in the class;

verifying information in the document using the identified data set;

extracting information from the document to process the document according to one or more tasks associated with the class.

According to a further aspect of the invention there is provided a computer program comprising machine-readable program code for controlling the operation of a data processing apparatus on which the program executes to perform a method of learning associations between classes of documents and one or more structured data sets, said method comprising the steps of:

classifying a document into a class selected from a predefined set of classes;

displaying one or more structured data sets, wherein the displayed structured data sets are dependent on association information for the class;

receiving one or more indications of changes to the displayed structured data sets; and

amending the association information for the class based on the received indications.

According to a further aspect of the invention there is provided a computer program comprising machine-readable program code for controlling the operation of a data processing apparatus on which the program executes to perform a method of extracting information for processing a document; the method comprising the steps of:

classifying the document into a class selected from a predefined set of classes, wherein said classifying is dependent on first information in the document;

identifying a data set based on second information in the document, wherein said identifying is dependent on association information adaptively obtained through processing other documents in the class;

extracting data from the document and the data set to process the document according to one or more tasks associated with the class.

According to a further aspect of the invention there is provided a computer program comprising machine-readable program code for controlling the operation of a data processing apparatus on which the program executes to perform a method of verifying information for processing a document, the method comprising the steps of:

classifying the document into a class selected from a predefined set of classes, wherein said classifying is dependent on first information in the document;

identifying a data set based on second information in the document, wherein said identifying is dependent on association information adaptively obtained through processing other documents in the class;

verifying information in the document using the identified data set;

extracting information from the document to process the document according to one or more tasks associated with the class.

According to a further aspect of the invention there is provided a system for learning associations between classes of documents and one or more structured data sets, said system comprising:

data storage for storing at least one document, association information for a predefined set of classes of documents, and one or more databases; and

a processor in communication with the data storage and adapted to:
classify a document into a corresponding class selected from the predefined set of classes;
display one or more structured data sets derived from the one or more databases based on the association information for the corresponding class;
receive one or more indications of changes to the displayed structured data sets; and
amend the association information for the corresponding class based on the received indications.

### BRIEF DESCRIPTION OF THE DRAWINGS

One or more embodiments of the invention will now be described with reference to the drawings, in which:

FIG. 1 is a flowchart depicting a method of extracting data from unstructured documents;

FIG. 2 is an example of a graphical user interface for use in the method of FIG. 1;

FIG. 3 is a flowchart depicting a method of document classification for use in the method of FIG. 1;

FIG. 4 is a flowchart depicting a method of data extraction for use in the method of FIG. 1;

FIG. 5A is a flowchart depicting in more detail the text extraction step of the method of FIG. 4;

FIG. 5B is a flowchart of the step of computing a membership score in the method of FIG. 5A;

FIG. 6 is an example of a document divided into text blocks;

FIG. 7 is an example of a document whose contents have been partitioned into four distinct regions for use in the method of FIG. 5;

FIG. 8 is a flowchart showing a method of learning associations between documents and structured data sets;

FIG. 9 is an example of a feature vector used for document classification;

FIG. 10 shows the how the feature vector is constructed for the process of verifying candidates for data extraction using the method of FIG. 5; and

FIG. 11 is a schematic block diagram of a computer system on which the described arrangements may be performed.

### DETAILED DESCRIPTION INCLUDING BEST MODE

The arrangements described herein are well suited for the extraction of information from scanned unstructured documents such as letters, memos and faxes, although the methods are not limited to the processing of unstructured documents.

In unstructured documents, also known as free-form documents, the layout and content of the document are not fixed and may vary significantly for each document of a particular category, or pertaining to a particular task such as changing the address of a bank account. Nearly all letters have some elements of predefined structure, for example a date at the top of the letter, a signature at the end of the letter, and a standard opening such as “Dear Madam”. However, such minimal elements of predefined structure are not sufficient to qualify a document as structured.

Structured documents typically have a regular and hence predictable structure, and for this reason are often referred to as forms. In a structured document, most or all of the elements are presented in a fixed location or a fixed configuration relative to the other elements in the document.

The described arrangements can also be used to process emails, which tend to have little or no structure.

Processing Incoming Documents

Many large processing centres, such as the back offices of banks, receive a large amount of paper-based correspondence. Typically, the first step for these organisations is to scan the incoming correspondence and then route the images of the scanned documents, in addition to incoming faxes, to the electronic inboxes of operators. These operators then process the electronic forms of the correspondence by verifying that information in the correspondence is correct and extracting information from the electronic documents required for subsequent processing. Examples include account information and details of cheques to be stopped, and information required to start a new bank account or to close an existing account.

If the scanned correspondence can be recognised as a standard form then the organisation can use forms recognition software packages to automate the verification and collection of data from the scanned document. However, if the correspondence is unstructured, then forms cannot be designed for all the possible variations of documents received for a particular task, such as stopping payment of a cheque. This means that the task of verifying and extracting information from unstructured documents is left to the operator. In many cases much of the information to be extracted from these documents is re-keyed by the operators because of the difficulty of electronically extracting the relevant information from images of scanned documents.

The arrangements described herein are described with respect to the semi-automated processing of scanned unstructured documents. However, the described arrangements could also be used to process email correspondence in a substantially similar manner.

A document image may be obtained by scanning a physical document. This document image can be analysed to determine the structure and textual content of the document. Preferably, regions containing image content and textual content are identified and treated as separate regions. The structure of a document is represented as a set of connected regions. Further processing is then performed on those regions that contain text in order to recognise the individual characters of the text region. This process of recognising the individual characters is called optical character recognition (OCR). A suitable method of performing OCR is described in U.S. Pat. No. 5,680,479 entitled “Method and Apparatus for Character Recognition” and issued on 21 Oct. 1997. Other OCR methods may also be used.

The result of the document image analysis is that a document image can be stored with generated metadata (i.e., block locations and positions and identities of individual characters recognised by the OCR processing).

In the preferred arrangement, the generated metadata is represented as an Extensible Markup Language (XML) document. Each page of a document is represented by an XML tag and is associated with a hypertext link to the document image for the page. Each rectangular region within each page is then represented by a further tag, which includes the block's x and y coordinates, height and width. If text has been identified within the block, then each identified character and the character's position and bounding rectangle is represented by a further XML tag within the region tag. An attribute which represents the confidence level for the detection of the character is also included.

Clearly, other ways of representing the generated metadata for the scanned document image may also be used.

Implementation

The document images may be processed in a scanning device itself such as an office scanner or multifunction device, or by a software application residing in a general purpose computer. In the latter case, the scanning device may route the scanned document image to a computer on a network, where the processing to create the metadata would occur.

The present specification discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present invention also implicitly discloses a computer program, in that it would be apparent to the person skilled in the art that the individual steps of the preferred method described herein are to be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing the spirit or scope of the invention. Furthermore one or more of the steps of the computer program may be performed in parallel rather than sequentially.

Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

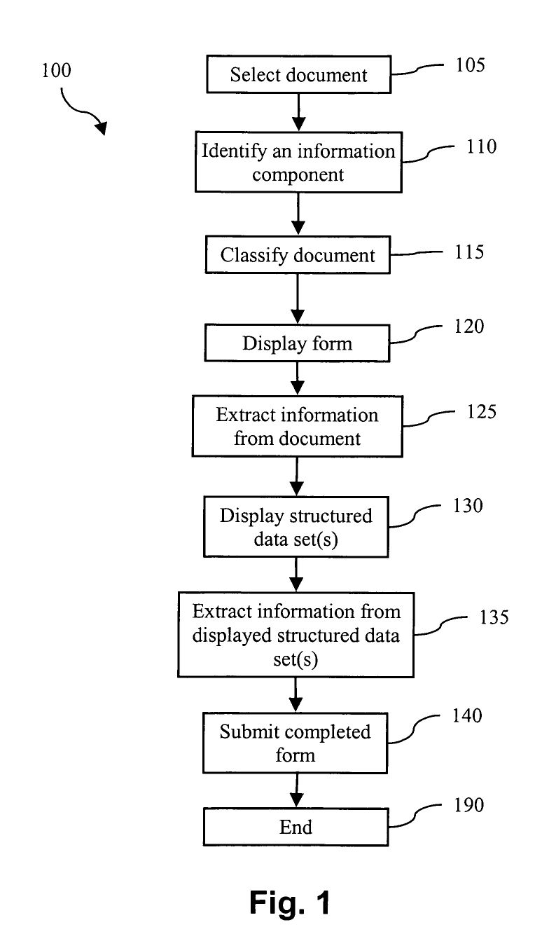

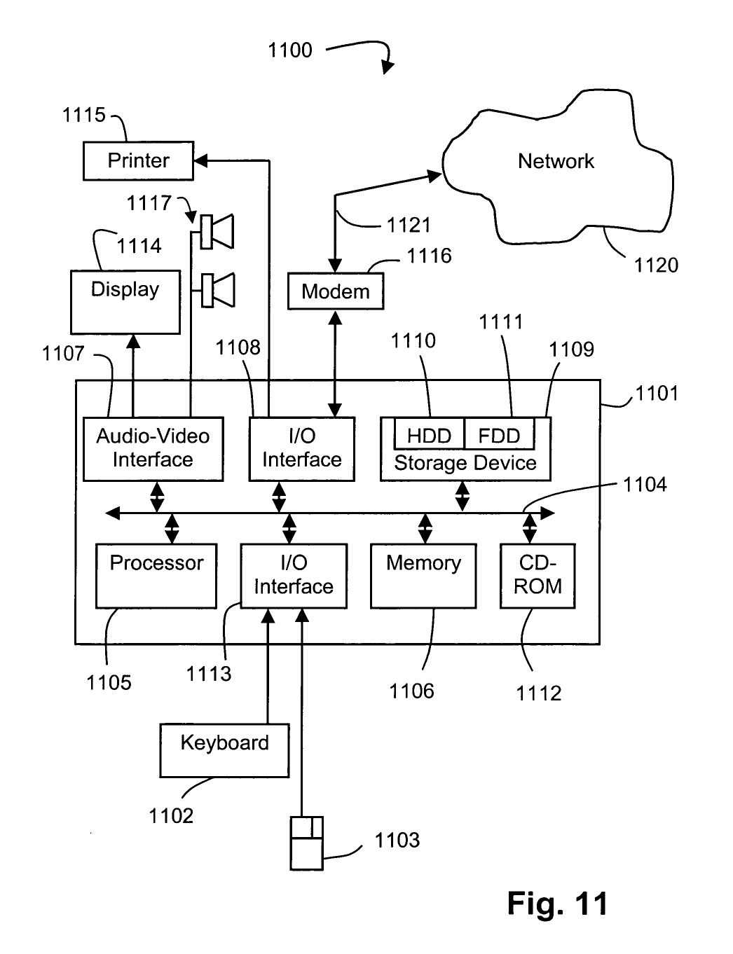

The methods of extracting data from unstructured documents and learning associations between unstructured documents and data sets is preferably practiced using a general-purpose computer system 1100, such as that shown in FIG. 11 wherein the processes of FIGS. 1, 3, 4, 5 and 8 may be implemented as software, such as an application program executing within the computer system 1100. In particular, method steps are effected by instructions in the software that are carried out by the computer. The software may be stored in a computer readable medium, including the storage devices described below, for example. The software is loaded into the computer from the computer readable medium, and then executed by the computer. A computer readable medium having such software or computer program recorded on it is a computer program product.

The computer system 1100 is formed by a computer module 1101, input devices such as a keyboard 1102 and mouse 1103, output devices including a printer 1115, a display device 1114 and loudspeakers 1117. A Modulator-Demodulator (Modem) transceiver device 1116 is used by the computer module 1101 for communicating to and from a communications network 1120, for example connectable via a telephone line 1121 or other functional medium. The modem 1116 can be used to obtain access to the Internet, and other network systems, such as a Local Area Network (LAN) or a Wide Area Network (WAN), and may be incorporated into the computer module 1101 in some implementations.

The computer module 1101 typically includes at least one processor unit 1105, and a memory unit 1106, for example formed from semiconductor random access memory (RAM) and read only memory (ROM). The module 1101 also includes an number of input/output (I/O) interfaces including an audio-video interface 1107 that couples to the video display 1114 and loudspeakers 1117, an I/O interface 1113 for the keyboard 1102 and mouse 1103 and optionally a joystick (not illustrated), and an interface 1108 for the modem 1116 and printer 1115. In some implementations, the modem 1116 may be incorporated within the computer module 1101, for example within the interface 1108. A storage device 1109 is provided and typically includes a hard disk drive 1110 and a floppy disk drive 1111. A magnetic tape drive (not illustrated) may also be used. A CD-ROM drive 1112 is typically provided as a non-volatile source of data. The components 1105 to 1113 of the computer module 1101, typically communicate via an interconnected bus 1104 and in a manner which results in a conventional mode of operation of the computer system 1100 known to those in the relevant art.

Typically, the application program is resident on the hard disk drive 1110 and read and controlled in its execution by the processor 1105. Intermediate storage of the program and any data fetched from the network 1120 may be accomplished using the semiconductor memory 1106, possibly in concert with the hard disk drive 1110. In some instances, the application program may be supplied to the user encoded on a CD-ROM or floppy disk and read via the corresponding drive 1112 or 1111, or alternatively may be read by the user from the network 1120 via the modem device 1116. Still further, the software can also be loaded into the computer system 1100 from other computer readable media. The term “computer readable medium” as used herein refers to any storage or transmission medium that participates in providing instructions and/or data to the computer system 1100 for execution and/or processing. Examples of storage media include DVDs, USB memory devices, CD-ROM, a hard disk drive, a ROM or integrated circuit, a magneto-optical disk, or a computer readable card such as a PCMCIA card and the like, whether or not such devices are internal or external of the computer module 1101. Examples of transmission media include radio or infra-red transmission channels as well as a network connection to another computer or networked device, and the Internet or Intranets including e-mail transmissions and information recorded on Websites and the like.

Method of Processing an Unstructured Document

FIG. 1 shows a method 100 of processing a document. In step 105 of method 100 the operator selects an unstructured document to be processed. Preferably, this document is the next document in a list of documents to be processed and is represented using the XML structure described above. The list of documents to be processed is stored in an inbox on a network server and may be accessed by a number of operators. Alternatively, each operator could have his or her own individual inbox, which contains all the documents allotted to him or her for processing. These documents may have been automatically allocated on the basis of available time, skill sets or other parameters available to an allocation system. Individual inboxes could be stored either on a central server (as separate inboxes) or on the local computers of the operators. The selection of the document to be processed may be automated to simply display the next document available in the inbox when the processing of the previous document is completed.

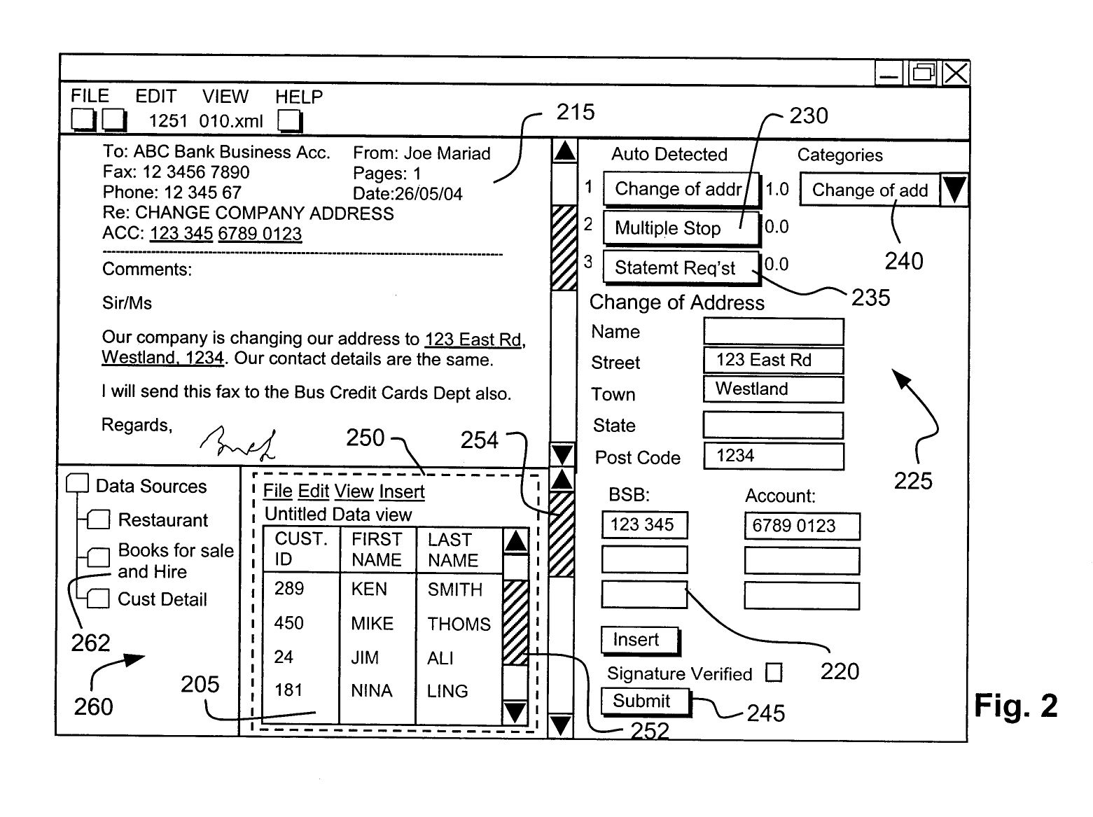

In one arrangement, the selected document image is displayed in a graphical user interface (GUI) substantially as shown in FIG. 2. The document image 215 is displayed in the panel in the top left hand side of the GUI in FIG. 2 using a standard image format such as PNG, TIF or JPEG. Preferably, prior to display, the document structure has already been determined for the document image and the text obtained by the OCR processing of the text regions in the document image is stored associated with the document image. There is a known association between positions on the screen, the boundaries of the text and image regions, and the locations of individual characters (in the text regions).

In step 110 one or more information components in the document are identified. In the described arrangement, information components are text strings obtained by concatenating characters recognised in the OCR processing. These text strings are then input into a classifier which, in step 115, attempts to classify the current document according to one of a number of predetermined classifications. In alternative arrangements information components may not be limited to text strings. For example, information components could be derived from image regions detected in the document image and therefore represent properties of the image (e.g., colour, texture, shape of contained objects, etc.). Graphical objects such as icons or ‘emoticons’ (emotion icons using keyboard symbols to convey information) in a source document may also be the source of information for classification.

The predetermined classifications correspond to the purposes of incoming documents. For example, a back office for a bank may have classifications for starting a new account, closing an account, changing the address(es) for accounts, stopping payment of cheque(s), credit card applications, lost credit cards, invoices, liquidator notices for business accounts, etc. Each type of correspondence requires different type of data to be extracted from the unstructured document, in order for the bank to be able to electronically process the request or notification. Each organisation is likely to have its own set of classifications, each classification corresponding to a particular request or notification and requiring a particular set of data to be extracted for subsequent processing.

In the described arrangement, each classification is associated with an output form which contains editable fields for each unit of information that needs to be completed before the request or notification can be processed. Preferably, these output forms are completed by automatically extracting data from the displayed document where possible. Where not possible, text components can be copied from the displayed document using a mouse or a keyboard to highlight the necessary text. The copied text may then be pasted into the output form. In the example GUI in FIG. 2, the output form 225 is shown to the right of the displayed document 215.

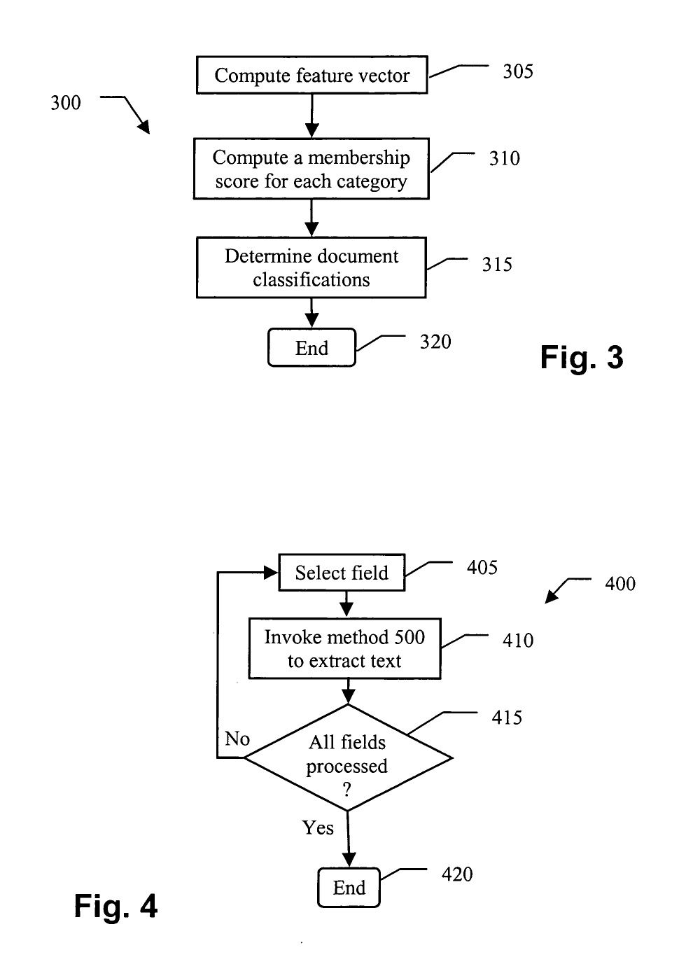

The classifier is described in more detail later with respect to FIG. 3. The classifier generates a probability for each of the possible classes for the currently displayed document (e.g., 215 in FIG. 2). In step 120 the output form 225 is displayed for the class that has the highest probability. Shortcut buttons 230 and 235 provide quick access to the two next most probable classes. If the classification is incorrect, the user can manually alter the classification by either selecting one of the shortcut buttons 230 or 235, or selecting the required class from the pull-down menu 240 in FIG. 2. When the classification is changed, the displayed output form 225 is changed to correspond to the new classification. The new output form could have quite different data fields because the corresponding request or notification may require quite different information to be extracted.

The displayed output form 225 shows what information needs to be extracted from the current document before it can be processed. Once the output form has been completed with data, the form can be processed and the office databases updated with the information from the document. Preferably the processing of the completed output form is performed by a process operating on a server that is accessible from the software application being described. When the form is completed, the user can press the ‘submit’ button 245 and this action will cause the completed form to be despatched to the server process for processing.

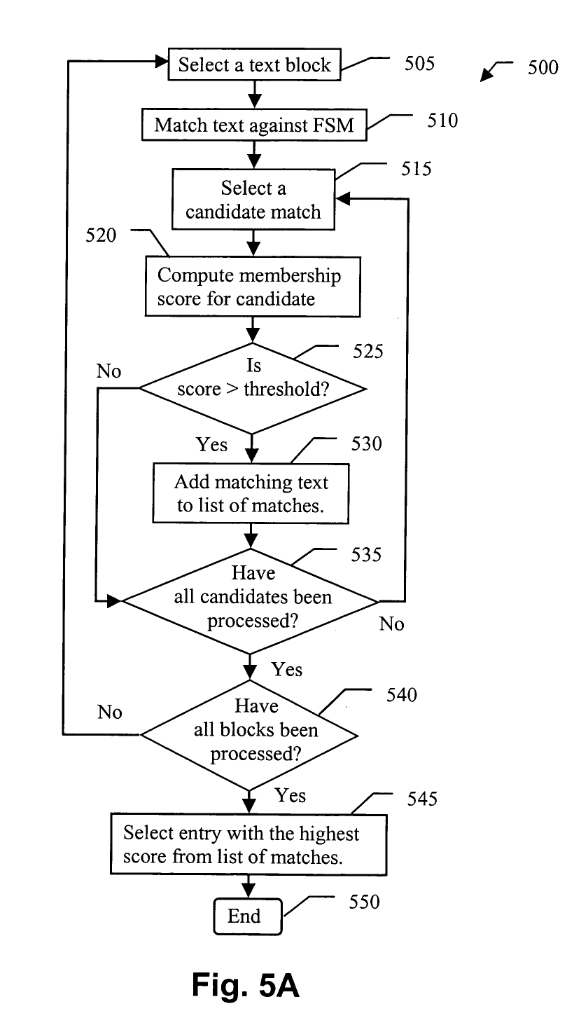

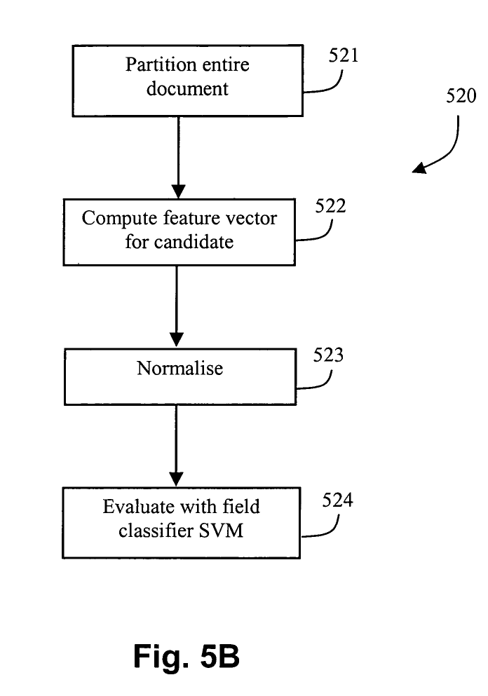

After classifying the document in step 115 and displaying the appropriate output form in step 120, the method 100 proceeds to attempt to extract relevant information from the document in step 125. The relevant information depends upon the classification. If the document has been classified as a request to change address, for example, the relevant information to be extracted would consist of the account number, the account holder's names and the new address. Clearly, other classifications may require different information to be extracted from the document (e.g., cheque numbers and cheque dates, etc.). Each classification is associated with the data types that are required to be extracted for documents of that classification. In many cases, it is not possible to extract all the required data. This may be because the data has been omitted in the document or the extracted data cannot be correctly detected. The method used to extract the required data is described later in this description with reference to FIGS. 4 and 5.

Extracted data is displayed in the output form for the user to verify and correct if necessary. In addition, the user can use the keyboard and mouse to copy data from the document directly into the output form.

If the operator selects to manually amends or changes the classification, then the new output form is displayed as described for step 120 and the data extraction is performed for the new classification as described for step 125.

As mentioned previously, extraction of data from unstructured documents is problematic because (i) the document often does not include all the data required for the output form; or/and (ii) the operator must verify that certain information in the document is correct before submitting the output form 225 for further processing. These problems mean that the operator must often view information in a company's databases in order to complete the processing for the document. For example, a letter from a customer to a bank requesting to close an account may state the account number to be closed but omit the bank branch identifier. This means that an operator must query the account data for the bank to (i) identify the branch identifier, and also possibly (ii) verify that the customer's details are correct (e.g., the customer may have mis-quoted their bank account number). Typically, this is achieved by the operator selecting to view the results of a database query which returns account details for the bank's customers.

Each view of data, or data view, is a visualisation of a structured data set. The visualisation is specified by a query that defines which data is to be selected from the database. For example, if a company uses a relational database such as SQL Server from Microsoft Corporation to store all its customers' account details, the operator would need to be able to specify a query using the Structured Query Language (SQL) to select the account codes of relevant customers. This query would then be submitted to the database and the resulting structured data set displayed as a data view for the operator. The operator could then verify information contained in the document or identify any information which may be missing from the document that he/she is processing. Obviously, this manual process of finding relevant structured data sets to either verify or complete data in the document to be processed is time-consuming and error prone.

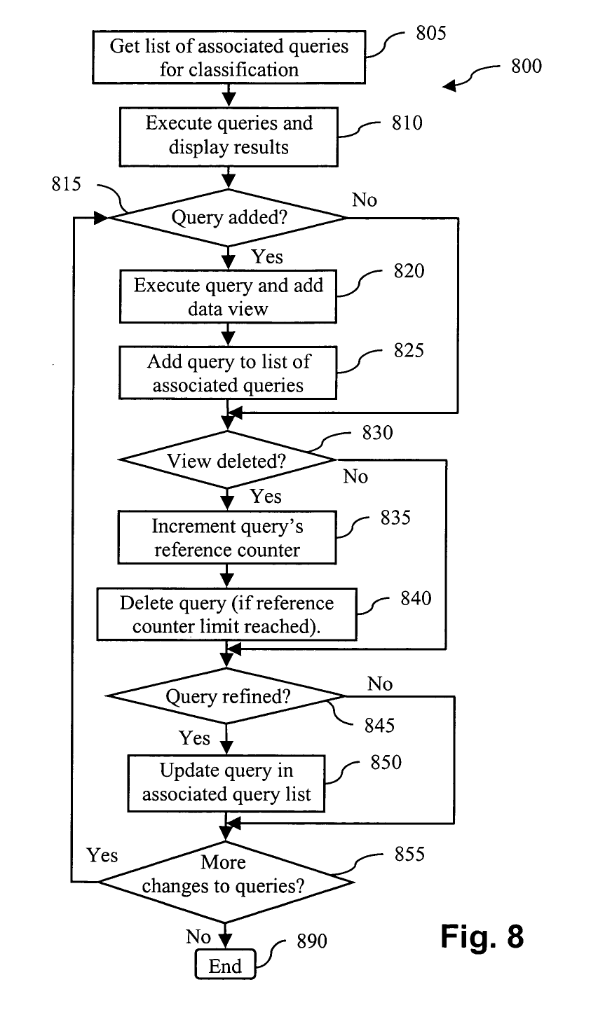

In the described arrangement, unstructured documents are associated with structured data sets. The structured data sets may assist the operator to either verify information contained in the document or complete the information needed for the output form 225. Associated structured data sets can be determined from a knowledge of the classification being used for the document and also from data contained in the document. Furthermore, associations between unstructured documents and structured data sets are learned and refined by observing the operator's actions in processing a document. For example, if the operator manually selects to view a new data view to process a document, then the query associated with the new view becomes associated with the document's classification in the future. This learning of associated queries is described further in this description with reference to FIG. 8.

In step 130 any structured data sets that have been previously associated with the current classification are displayed as data views in the data viewer panel 250 in FIG. 2. An example data view 205 showing account details is shown in FIG. 2. This data view is the result of processing a query, which defines a structured data set that is associated with the document's classification. There may be a number of associated structured data sets for each document to be processed.

In the described arrangement, the queries are represented using the XML Query Language, XQuery. This language is developed by the World Wide Web Consortium. XQuery uses the structure of XML to express queries across all types of data, whether the data is physically stored in XML or viewed as XML via some middleware such as a data server. When an XQuery expression is processed, the structured data set result is represented using XML.

For example, the following XQuery expression will generate an XML result element for each Account element in the XML document, http://abc.com/Accounts.xml.

```
<results>
{
    for $a in doc(“http://abc.com/Accounts.xml”)/Account
    return
        <Account>
            { $a/AccountName }
            { $a/Code }
            { $a/BranchCode }
            { $a/Address }
        </Account>
}
</results>
```

Network-addressable services can be provided to translate data, stored in databases of different type and form, to XML. In other words, XML is used to normalise heterogeneous data and the XQuery language is used to query or select data using the XML normalised form.

The structured data set result of an XQuery expression is displayed graphically as a data view 205 in the data viewer panel 250 in FIG. 2. Preferably, the structured data sets are displayed as tables. However, other graphical representations of data may also be used (e.g., graphs, charts, etc.).

As mentioned before the associated structured data sets are determined using queries that the system has learned to associate with the individual classifications. These learned queries can also include parameters, which include data that has been extracted from the document being processed. For example, if it was learned that it is more efficient to display only those accounts from the relevant branch as the structured data set, the query associated with the document may use the branch code that has been extracted from the document. Data extraction is described in more detail later in this description with reference to FIG. 4. In the query below, the system variable $V1 is used to contain the branch code that has been extracted from the document. Before initiating queries that will generate associated structured data sets, any system variables in the queries are first instantiated with data that has been extracted from the document.

```
<results>
{
    for $a in doc(“http://abc.com/Accounts.xml”)/Account
    where $a/BranchCode = $V1
    return
        <Account>
            { $a/AccountName }
            { $a/Code }
            { $a/BranchCode }
            { $a/Address }
        </Account>
}
</results>
```

Other information relevant to the task may be extracted or verified from the displayed data sets in step 135. This is necessary because often the document does not contain all the information to perform the task. For example, as described above the document might fail to identify the branch at which the account is held. This information can be extracted from an associated structured data set displayed in step 130 of method 100. The operator can then copy and paste the appropriate information from the displayed structured data set into the output form 225. The step of displaying associated structured data sets therefore makes it easier for the operator to complete the data. It eliminates the need for the operator to exit the current application and enter other applications for the purpose of finding information that is required to complete the processing of the document.

In addition, the output form for a classification may require the operator to check a check box to indicate that he/she has verified certain critical information. This could include verifying that the signature on a document is consistent with the digital signature displayed as part of the structured data set (e.g., as a linked image in the XML query result). Verification of name and address information may also be required on critical tasks like closing an account. In some cases, all the data required by the output form may be extracted from the document. If this is the case, the displayed structured data sets may only be required for verification purposes.

When all the necessary information has been added to the output form, then in step 140 the operator can select to submit the output form by pressing the submit button 245 of the output form 225 in FIG. 2. This action causes the output form to be submitted to a server for processing. The processing of the document completes in step 190. Preferably, the next document in the list is displayed in readiness for processing using the method 100.

Associating Structured Data Sets with Documents

The method by which the method 100 learns to associate structured data sets with documents will now be described in more detail with reference to FIG. 8. Each classification is associated with zero or more associated queries. These queries may contain system parameters, as described previously, and therefore may also depend on extracted data for execution.

In an alternative arrangement, if data for parameters is not available and the parameters are included in query constraints (e.g. the XQuery ‘where’ construct), then the constraints may be ignored.

When a document is classified, the associated queries are executed, resulting in a data view being displayed in the data viewer panel 250 for each associated query.

The method 800 begins in step 805 by obtaining the list of queries that are currently associated with the current document's classification. These queries are executed and their results displayed in the data viewer panel 250 of FIG. 2 in step 810. In the preferred arrangement, this panel is implemented as a Scalar Vector Graphics (SVG) panel. However other methods of displaying the results of queries can also be used.

If the queries contain system parameters then the system attempts to provide the parameters using the data that has been extracted from the document. If this is not possible, a dialogue box is provided so that the operator can manually specify values for the parameters.

An operator can interact with the displayed graphics of the data view by selecting scroll bar 252 and scrolling through the displayed data. In addition, the operator can scroll the entire data viewer panel 250 to see further data views by selecting and interacting with the scroll bar 254. The operator may cut and paste data from the data view into the output form 225 from the displayed data. For example, data from data views can be copied to the Windows clipboard using standard Windows operating system copy operations such as Control C (Windows is a trademark of Microsoft Corporation). The copied data can then be pasted into the output form as required.

The GUI shown in FIG. 2 includes a bookmarks panel 260 on the left hand side of the screen. This panel contains a list of bookmarks that operators may commonly use while processing documents. Preferably, each of these bookmarks (for example, bookmark 262) represents an XQuery expression. Selection of a bookmark results in the structured data set result of the query being displayed in the data viewer panel 250 as a data view (for example data 205).

Returning to method 800, the operator may choose in step 815 to add a further data view to the data viewer panel 250. This may be necessary because the current document may not contain necessary information that most documents of the same classification include. Alternatively, the document may differ slightly in purpose from other documents that are similarly classified. Consequently, data from a different structured data set may be required to complete the processing of the document. The operator can select to view another structured data set by either selecting the corresponding query in the bookmarks panel 260 or manually specifying the query in a dialog box provided for this purpose.

The query is then executed and the resulting structured data set result is displayed as a data view in the data viewer panel 250 in step 820. If the query represented by the bookmark query contains system parameters, as previously described, then an attempt is made to provide the parameters using the extracted data. The new query is then added to the list of associated queries for the classification in step 825. This means that the next time a document having the same classification is being processed, this structured data set will be automatically displayed for the operator. In other words, the method 800 has learned to associate this structured data set with the documents having a similar classification.

If the operator selects to delete an existing data view from the data viewer panel 250 in step 830, then a reference counter associated with the query is incremented in step 835. If the query's reference counter is greater than a specified limit, the query is removed from the list of queries associated with the classification in step 840. This means the query will no longer be automatically displayed when a document, which is similarly classified, is subsequently processed. Preferably, the value of the reference counter limit can be adjusted. However, the default value used in the described arrangement is 5.

In step 845, the operator can select to refine an existing query by modifying the associated data view in the data viewer panel 250. An existing query can be refined by applying further constraints to the query (e.g., specifying further filters for the data) or sorting criteria. Refined queries can be added to the list of bookmarks in the bookmarks panel 260. The method of graphically refining queries to create new XQuery expressions is preferably achieved using the method described in U.S. application Ser. No. 10/465,222, publication number 20040015783, or the counterpart Australian application 2003204824. However, other methods of refining existing queries to generate new XQuery expressions may also be used.

Queries may also be refined by the addition of system parameters. If the method 800 can detect a filter, scrolling or copy operation which is associated with an item of extracted data (e.g., an extracted name, account number, etc), then the query associated with the data view can be refined to include a constraint involving a system variable. When this refined query is executed in the future, the step 130 of method 100 will attempt to use extracted data to complete the query before it is executed. Refinement of a query results in the query being updated in the list of associated queries.

If the operator has more changes to make to the displayed data views in step 855, then control returns to step 815, where a check is made to see if an new query has been added. If no further changes are required, then the method ends at step 890.

In addition to the method of passive association and disassociation described with reference to FIG. 8, the preferred arrangement also allows an operator to manually associate and dissociate queries from classifications (i.e., active dissociation). In this case, the operator selects an option from the context menu of a data view to either associate or dissociate the query from the classification. The query is immediately either added or removed from the list of associated queries. Alternative methods of association and dissociation can also be used. For example, method 800 may be modified to allow queries to be dissociated if the corresponding data view is not used by an operator for a specified number of documents for a particular classification. Also, it may be necessary to observe more than one association action before a query is associated with a classification.

In one arrangement, the lists of associated queries are maintained on a central server and are updated based on the activities of all the operators working on the set of incoming documents. This means each operator experiences the benefit of the updated set of associated queries. In an alternative arrangement, a set of associated queries may be maintained for each operator.

Preferably, the changes to the list of associated queries are effected as the operator interacts with the GUI (as shown in FIG. 2). In alternative arrangements, it is possible that any changes to this list remain pending until the operator selects to submit the current form for processing.

The objectives of the method for associating structured data sets are three-fold. First, the method aims to provide necessary related information for the operator in a way that requires little effort on the part of the operator. Second, the method aims to limit the amount of unnecessary information that is displayed. Finally, the method enables the list of associated queries to be adapted to any systematic changes in the nature of the documents that are processed and the way documents are processed. The described arrangement is able to adapt to such changes without the need for an expert to have to modify the system.

Although the method for learning associations between documents and data sets is described with respect to unstructured documents, the method of FIG. 8 may also be applied to structured documents such as forms. Form-processing software may not be able to fill all the required fields in the form, and it may be necessary to obtain further information from data sets to complete the form. The described methods may contribute to the efficiency of such data extraction.

Document Classification

The document classification process will now be described in more detail with reference to FIG. 3. The input to process 300 is either a document that has undergone a pre-processing step in which one or more word and word strings have been identified from a scanned image of the document, or an electronic document such as an email that is already in a form where words and word strings are readily identifiable. In the case of scanned documents, the individual characters obtained by the OCR process are joined to form words and word strings of two or more words.

In step 305 a feature vector is computed for the input document by comparing the identified words and word strings against a dictionary 900 of valid words, compound words, names and pre-determined keywords and key-phrases. Preferably if documents to be processed by the present invention are in English then the valid words and compound words in the dictionary 900 are those found in a comprehensive English dictionary, and the names in the dictionary 900 may be obtained from lists of most popular names published by a government body such as the U.S. Census Bureau. Corresponding sources in different languages may be used for the dictionary 900 if the input documents are not in English.

The keywords and key-phrases in the dictionary are typically words and phrases that have been pre-determined to be significant in distinguishing between documents belonging to different classes. For example if the document classes include “Change of Address Notification”, “Statement Request” and “Credit Card Cancellation Request”, then keywords and key-phrases typically include “new address”, “change of address”, “statement request”, “bank statement”, “credit card”, and “cancel”.

Preferably entries in the dictionary 900 are stemmed using Porter's stemming algorithm whereby similar words with identical stems such as “run”, “running”, and “runner” are reduced to a single word “run”, which generally helps to improve the generalisation accuracy of the classification process. Preferably, the identified words and word strings in the input document also undergo the same stemming algorithm prior to their comparison against the stemmed dictionary 900 during the construction of the feature vector at step 305. A description of the stemming algorithm may be found in Porter, “An algorithm for suffix stripping”, Program, Vol 14, no. 3, 1980, pp 130-137.

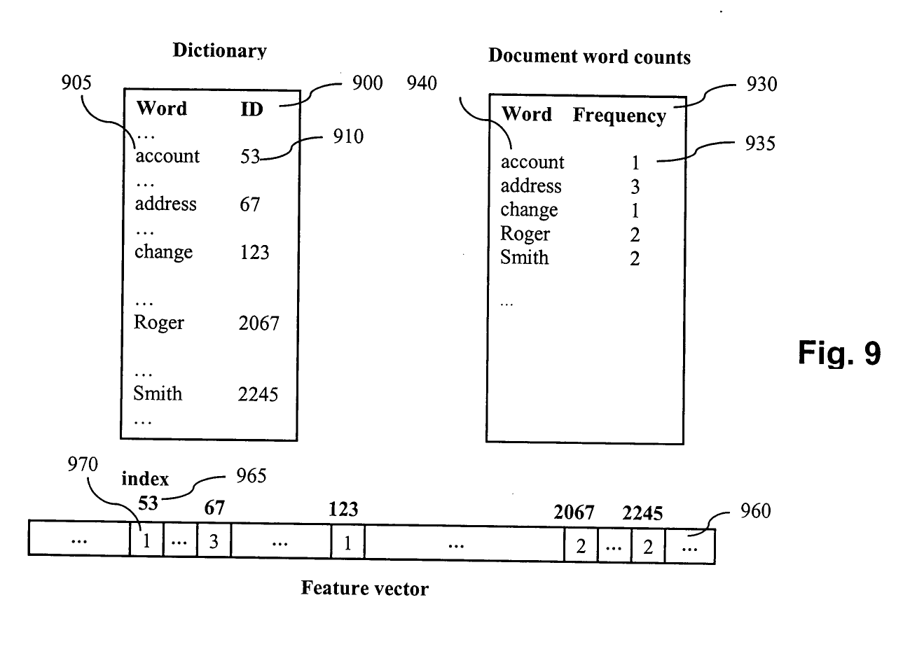

The feature vector preferably comprises one scalar element for each distinct entry in the stemmed dictionary 900, where the scalar element is assigned a value equal to the number of times a word or word string occurs in the input document (when stemmed). FIG. 9 illustrates the method of generating a feature vector 960 for a document. A word list 930 includes the stemmed words 940 from the input document and the frequency 935 of occurrence of each word in the document. In the example shown, the words “account” and “change” each appear once in the document, “Roger” and “Smith” each appear twice, and “address” appears three times.

The words 940 in wordlist 930 are matched against a dictionary 900 in which each entry 905 is associated with a unique ID 910. Thus, in the shown example, “account” has the ID “53”, “address” has the ID “67”, “change” has the ID “123”, “Roger” has the ID “2067” and “Smith” has the ID “2245”.

For each word 905 in the dictionary 900 that appears in the word list 930, an element 970 in the feature vector 960 whose index position 965 is the word's associated ID 910 is assigned a value equal to the corresponding word frequency 935 in the word list 930. In the shown example, the element 970 having the index 53 is assigned the value “1”, the element having index 67 is assigned value “3”, the element having index 123 is assigned “1”, and the elements having indices 2067 and 2245 respectively are both assigned the value “2”.

When an identified word does not occur in the dictionary 900, whether it be an unfamiliar word or an unrecognisable word that arises from a typing error or an error in the OCR processing step, preferably the word is ignored.

At step 310 the feature vector 960 obtained for the input document, is used to compute a membership score for each of the possible document classifications. A membership score is preferably a floating point value between 0 and 1 inclusive, indicating the degree or probability that the input document belongs to a document classification. Alternatively, the membership score may be an integer value 0 or 1 which correspondingly indicates that the input document does not belong to or belongs to some document class.

Preferably prior to computing the membership scores, the feature vector 960 undergoes a tfidf normalisation process, whereby each element of the feature vector is replaced by a normalised value according to the formulae

$${x}_{i}^{′} = {x}_{i} ln \frac{N}{{d}_{i}}$$

$${x}_{i}^{″} = \frac{{x}_{i}^{′}}{\vert {x}^{′} \vert}$$

where xᵢ is the i^{th} element of the un-normalised feature vector corresponding to the i^{th} entry of the dictionary, N is the size of a training set of documents used to train the classifier, dᵢ is the number of documents in the training set that contains the i^{th} entry of the dictionary, xᵢ′ is the i^{th} element of an intermediate normalised feature vector x′ whose magnitude is denoted by |x′|, and xᵢ″ is the i^{th} element of the final normalised feature vector. tfidf is a common normalisation technique in document classification employed to (i) de-emphasise words that appear across many training documents as these tend to have less discriminating power, and (ii) prevent larger documents from being favoured over shorter documents.

In one arrangement each membership score is computed using a Support Vector Machine (SVM). A SVM is a popular and effective classification method that has been applied to a wide variety of classification problems, including document classification. In its basic form, an SVM is a binary ‘yes’ or ‘no’ classifier. Given an input feature vector (e.g., of a document), an SVM determines its classification based on the position of the feature vector with respect to some pre-computed decision surface, typically a hyperplane in multi-dimensional space. If the feature vector lies on one side of the decision surface then the vector is assigned a ‘yes’ classification, whilst if the feature vector lies on the other side then the vector is assigned a ‘no’ classification. Typically the decision surface is computed in a preceding training step that ‘optimally’ separates a set of positive training feature vectors from another set of negative training feature vectors.

The following presents a brief mathematical formulation of SVMs. In its simplest form, an SVM classifies a given feature vector x by evaluating the hyperplane equation:
d=x·w−b (1)
where w and b are some pre-determined coefficients, where x w denotes a dot-product between the two vectors x and w. If d>0 then the feature vector x is said to be positively classified, otherwise it is negatively classified.

The coefficients w and b are computed during a training phase such that the resulting hyperplane separates a set of positive training examples from another set of negative training examples in some optimal sense. Each training example is denoted by the pair (xᵢ, yᵢ), where yᵢ=1 for a positive example and yᵢ=−1 for a negative example.

Ideally, w and b should be chosen such that all positive examples lie on one side of the hyperplane and all negative examples lie on the other side. This can be expressed mathematically as:
yᵢ(xᵢ·w−b)≧1∀i −(2)

To maximise the generalisation accuracy of the resulting classifier, the SVM seeks values for w and b that not only satisfy Eq (2) above but also maximise the separation distance between the resulting hyperplane and the nearest positive and negative examples. This is achieved by solving the optimisation problem:

Minimise |w|, subject to:
yᵢ(xᵢ·w−b)≧1∀i −(3)
The above problem formulation assumes that the positive and negative training examples are separable. Often however, it is not possible to find a hyperplane that entirely separates the two example sets. Consequently the following non-separable formulation is often used.

$$\begin{matrix}Minimise & \vert w \vert + C {\sum }_{i} {ξ}_{ i} \\ subject to & {y}_{i} ( {x}_{i} \cdot w - b ) \geq 1 - {ξ}_{ i} ∀ i \\ and & {ξ}_{i} \geq 0 ∀ i\end{matrix} \qquad ( 4 )$$

where ξᵢ are called slack variables introduced to allow the example points to violate the hyperplane constraints of the separable formulation. An attempt is then made to minimise the amount of violation by including the slack variables in the objective function. C is some positive constant chosen as a trade-off between the simultaneous aims of maximising the separation distance between the hyperplane and positive and negative example sets and minimising the slack variables. Both the separable and non-separable formulations can be solved using standard quadratic programming techniques. Preferably the non-separable formulation is used in the described implementation.

Multiple SVMs can be used together to create a multi-category classifier as opposed to a binary classifier that is possible with only a single SVM. A popular realisation method is to employ a separate SVM for each category. Each SVM is trained to distinguish between examples of one category against examples of all other categories.

Preferably the SVMs are trained one after another from a pool of labelled training documents, where an operator has examined and identified each document as either belonging or not belonging to any of the pre-determined categories. The document pool may be collected and labelled offline or may be collected over a period of time from a log of actual documents processed in some backend system. Prior to training, documents in the pool are appropriately re-labelled as either positive or negative training examples for each SVM.

SVM can be extended from a ‘yes’ or ‘no’ classifier to one that produces real valued membership scores by determining not only the side of the decision surface on which a feature vector lies, but also its distance from the decision surface. If a feature vector lies far to the ‘yes’ or ‘no’ side of the decision surface, then it is assigned a membership score of 1 and 0 respectively. Feature vectors lying somewhere in between the above two extremes are assigned intermediate membership scores. The result is a set of SVMs generating a set of membership scores which preferably denote the probabilities that an input feature vector belongs to each of the categories.

The classification process proceeds to step 315 where the membership scores are analysed to produce a set of classifications for the input document. Preferably in addition to the membership scores computed for the set of pre-determined categories at step 310, another membership score is computed at step 315 which denotes the probability p₀ that the input document does not belong to any of the pre-determined classes, as follows:

$${p}_{0} = {\sum }_{i = 1}^{n} ( 1 - {p}_{i} ) \qquad ( 5 )$$

where each of p₁, . . . pₙ denotes the probability or membership score that the input document belongs to one of the n predetermined classes.

In a typical usage scenario, input documents presented to the classification system do not always belong to one of the pre-determined classes, and thus need to be correctly recognised as such. This allows the system for example, to either reject the documents (which may then be re-routed to other systems for processing), or to create a new class within the classification system (either automatically or with an operator's assistance) so that similar documents can be handled in the future. The probability that a document does not belong to any of the pre-determined categories computed by Eq (5) above provides a mean for recognising such documents. If Eq (5) results in a probability that is higher than the highest membership score computed in the previous step 310, then it is most likely that the input document belongs to a new category.

Preferably, a list of possible classifications for the input document is created in step 315, which comprises the list of predetermined classes and their associated membership scores plus an additional ‘New Category’ classification whose associated membership score is computed by Eq (5). The list of classifications is then ranked according to the membership scores, from highest to lowest. Preferably the top few (typically three) ranked entries are presented to the user as recommended classifications of the input document, with the top-ranked being the most likely class.

In an alternative arrangement, the list of possible classifications for the input document created in step 315 comprises only the list of pre-determined categories and their associated membership scores, ranked according to the membership scores, from highest to lowest. An additional ‘New Category’ category is added to the top of the ranked list only in the event that the sum of the membership scores in the list is less than some threshold value (for example 0.5). In any case preferably the top few (typically three) ranked entries are presented to the user as recommended classifications of the input document, with the top-most being the most likely classification. The classification process then ends at step 320.

Extracting Data from Documents

The method of data extraction will now be described. Most automatic information extraction systems operate by applying pattern matchers to the unstructured text to locate possible candidates for the information to be extracted (eg. customer address or bank account number), together with some additional means for accepting or rejecting each candidate.

A problem with existing automatic information extraction systems is that most only employ local information (i.e. text in the vicinity of a candidate) to evaluate the candidate. Prior art systems that employ non-local information to evaluate a candidate only use a limited amount of non-local information. The difficulty with such prior art systems is that information relevant for accepting or rejecting a candidate is often located far away from the candidate text itself. For example, in a letter by a bank customer requesting a change of his/her address to be recorded, the address may be located at the top of the letter and the relevant information identifying it as the new address may be a sentence “Please update my address to the one shown at the top of the letter” somewhere in the body of the letter.

The data extraction method described herein uses substantially all information in the input document to identify the information to be extracted. Thus, keywords such as “new address” may in fact refer to an address within the document that is some distance from the keyword (for example “Please note my new address, which is given at the head of this letter”). The described method uses weights for each piece of information, the weights being obtained in a training phase. Using the described method, relevant non-local information within the document may be effectively identified. The concept of local and non-local information is more fully described below.

A prerequisite of most data extraction systems when operating on scanned documents, including the present arrangement, is the determination of the flow of text in the document. As a bitmapped representation of a document immediately after scanning does not contain any information regarding how lines of text follow one another, extracting data that spans more than one line of text is non-trivial. Fortunately, many state-of-the-art OCR systems are capable of not only concatenating individual characters into words and words into lines but also able to group adjacent lines in the same paragraph into a single distinct text block. This is typically achieved by comparing their position, fonts, spacing and horizontal margins.

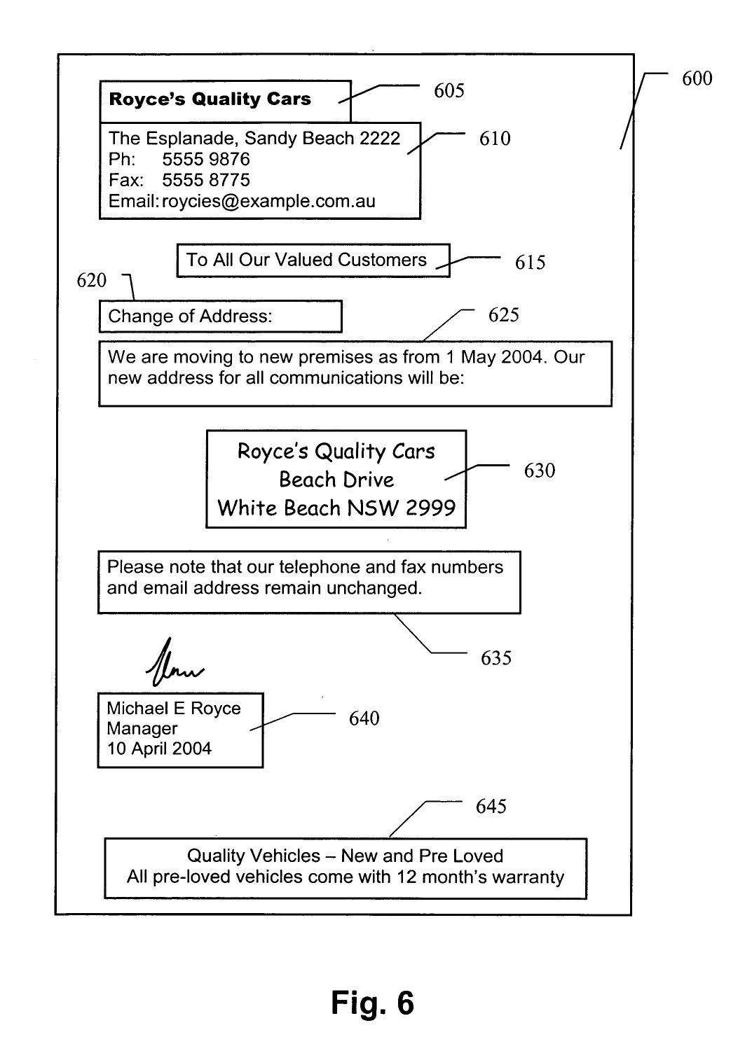

FIG. 6 shows an example of how text in a document 600 may be grouped into nine different text blocks 605, 610, 615, 625, 630, 635, 640 and 645. Once grouped, the text within each block can be converted into a single text string by concatenating lines in a top-down fashion and inserting spaces, carriage returns or other characters in between lines. In one arrangement, each text block so generated may contain more than one of the original text regions that were used to detect the parts of the image during OCR processing. For example, text block 610 includes text that was originally separated for the OCR processing. The text column containing “Ph:”, “Fax:” and “Email:” was originally distinct from the parallel column having as a first entry “5555 9876”.

Alternative algorithms for detecting the regions containing text may also be used.

The data extraction process will now be described with reference to FIG. 4. Each input document is assigned a document classification in classification step 115. The OCR processing has divided the document into a plurality of text blocks. Each document classification is associated with an output form 225 comprising a plurality of fields 220, most of which are to be filled, if possible, by data extracted automatically from the input document.

The data extraction process 400 begins at step 405 where a field in the output form 225 is selected for processing. At the next step 410, method 500 which is described below with reference to FIG. 5A, is invoked to extract text from the input document for populating the selected field in the output form. Method 400 then continues at step 415 which tests whether all fields in the output form have been processed. If not, execution returns to step 405 where an unprocessed field is selected for processing. If test 415 returns YES then method 400 terminates at step 420.

The method 500 invoked at step 410 is now described in detail with reference to FIG. 5A. Method 500 begins at step 505 where a text block is selected from the input document for processing. Typically each text block represents a paragraph in the input document. If the selected text block comprises a plurality of lines then the lines are preferably concatenated from top to bottom into a single continuous string with a single space character inserted between lines.

At the next step 510, the concatenated string is analysed to determine all sub-strings within the string that match a Finite State Machine (FSM) representing a string pattern for the field being extracted. An FSM conceptually comprises a plurality of states, including a starting state and an ending state, interconnected by links between states. Each state in an FSM is associated with a sequence of zero or more output characters or a character pattern. Preferably a character pattern is specified in a form known to those skilled in the art as a regular expression. An input string is said to match an FSM if there exists a path from the starting state to the ending state of the FSM, possibly through some intermediate connecting states, such that the concatenation of the sequences of characters or character pattern associated with each state along the path from the starting state to the ending state matches the input string. The FSM may be implemented in software.

Each matching substring of the input string is a possible extraction candidate for the current field. There may be more than one candidate matching the FSM, and hence it is necessary to identify the most likely candidate for extraction. For example, when the task is to extract a customer's new address from the customer's change of address notification letter, more than one address may appear on the letter, such as the customer's old address (i.e., the sender's address), the receiver's address, as well as the customer's new address. Consequently more than one candidate substring may match the ‘address’ FSM (which typically specifies that an address may have a street address, a town or suburb name, a state, territory or province name, and a post or zip code). Only one of these candidates may however be the actual entity to be extracted. For the above “change of address” example, this will be the customer's new address. In the example of FIG. 6, text blocks 610 and 635 both contain addresses.

The task of identifying the most likely candidate for extraction is preferably performed by applying a field classifier to each candidate to evaluate whether the candidate represents the data being sought for extraction. The process begins at step 515, in which a candidate is selected for evaluation. At the subsequent step 520, the field classifier computes a membership score for the selected candidate. Preferably the field classifier is an SVM, which assigns a membership score between 0 and 1. The candidate with the highest membership score is preferably deemed the ‘correct’ candidate if its membership score is above some threshold value (typically 0.5). If the highest membership score for all candidates is less than the threshold value, then no data is extracted for the present field. This allows for the possibility that a field being sought after may not be present in the input document.

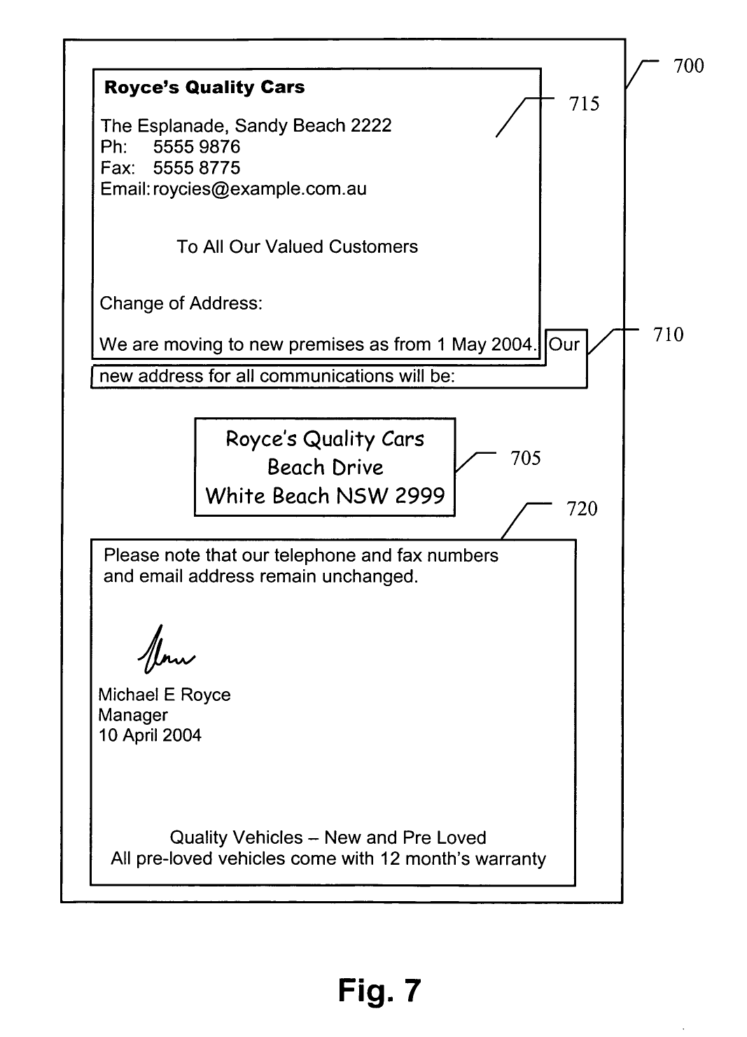

In order to obtain a membership score for each candidate through an SVM field classifier, a feature vector is constructed for each candidate. As illustrated in FIG. 7, the input document 700 is divided into four regions, namely the candidate 705, the pre-sentence 710, the pre-text region 715, and the post-text region 720.

The candidate region 705 is the candidate whose membership score is being evaluated. The candidate may comprise an entire text block or just a substring within it. In the example, the candidate being considered is the address “Royce's Quality Cars, Beach Drive, White Beach NSW 2999”, which corresponds to the whole of text block 630.

The pre-sentence region 710 preferably comprises a single sentence of text that immediately precedes the candidate region 715. The pre-sentence region 710 can be part of the same text block as the candidate text or reside in a different text block in the document. In the latter case the pre-sentence region is the last sentence in the text block that is preferably located immediately above or to the left of the text block where the candidate region appears. Other variations where the pre-sentence region 710 includes more than a single sentence of text or less than one sentence are also possible.

The pre-text region 715 includes all the parts of the document 700 that precede the candidate and pre-sentence regions. The pre-text region 715 includes all text blocks that appear above or to the left of the text block containing the pre-sentence region, as well as the text that precedes but residing in the same text block as the pre-sentence region. In the example, the pre-text region consists of text blocks 605, 610, 615, 620 and the first sentence of text block 625.

Finally the post-text region 720 includes all the remaining parts of the document 700 other than those in the candidate, pre-sentence and pre-text regions. In the example, the post-text region 720 consists of text blocks 635, 640 and 645.

In an alternative arrangement, the document is divided into only two regions. The candidate element is the first region and the remainder of the document is the second region.

In step 520 a membership score is computed for the currently selected candidate. Details of step 520 are shown in FIG. 5B. In step 521 the input document is partitioned into four regions 705, 710, 715, 720 as described above. Then, in step 522 sub-feature vectors are calculated, one for each of the four regions of the input document, namely the candidate 705, pre-sentence 710, pre-text 715 and post-text 720 regions described earlier. The sub-feature vector for each of the pre-sentence, pre-text and post-text regions is preferably created by comparing words and word strings in the region against a dictionary of valid words, compound words, names, commonly used phrases and pre-determined keywords and key-phrases. Preferably the word and word strings as well as entries in the dictionary are stemmed using Porter's Stemming Algorithm prior to their comparison. The keywords and key-phrases in the dictionary are pre-determined to be significant in distinguishing the ‘correct’ candidate from other candidates.

In the described arrangement, the created sub-feature vector comprises one scalar element for each entry in the stemmed dictionary, where the scalar element is assigned a value equal to the number of times a word or word string in the corresponding document region when stemmed matches the corresponding dictionary entry. When an identified word does not occur in the dictionary, whether it be an unfamiliar word or an unrecognisable word that arises from a typing error or an error in a OCR pre-processing step, preferably the word is ignored.

The sub-feature vector for the candidate region is created in the same way as the other regions as described above, except that the vector for the candidate region preferably comprises extra elements (in addition to elements corresponding to dictionary words) that refect the way in which text in the candidate region matches the FSM for the field being extracted. Preferably each of these extra elements corresponds to a state in the FSM, and is assigned a value equal to the number of times that state is visited in a path from the starting to the ending states in the FSM that matches the candidate text. Typically each state in the FSM specifies a certain string pattern such as a postcode or zip code, or a street name, and hence the extra elements in the sub-feature vector so created indicates the presence of these string patterns in the candidate text.

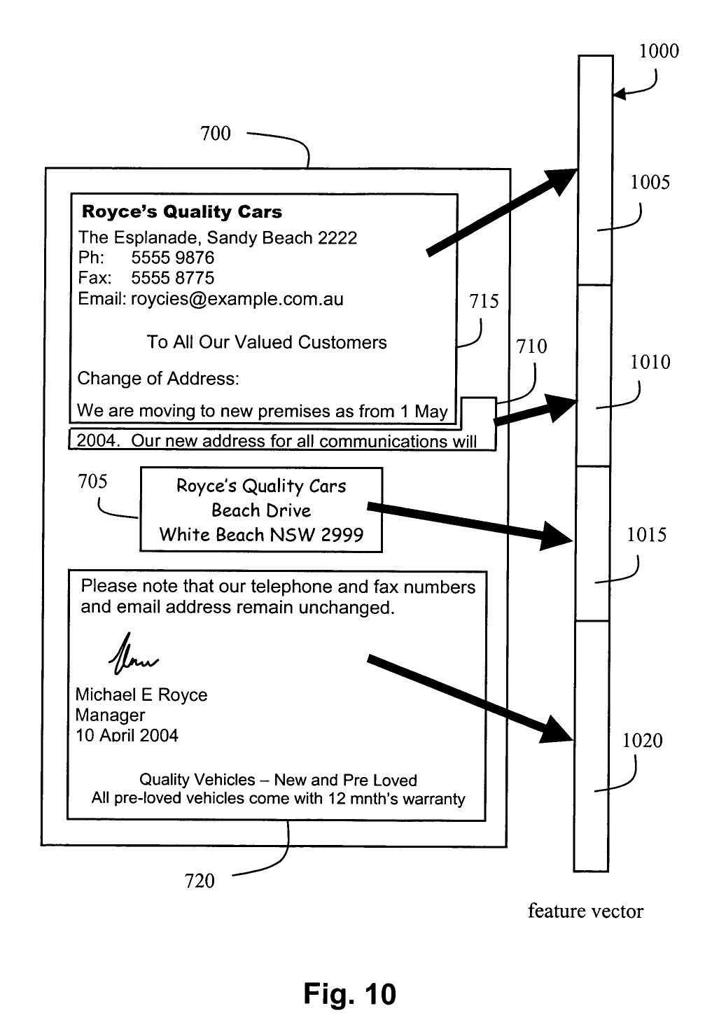

The four different sub-feature vectors are then concatenated into a single feature vector 1000, as shown in FIG. 10, In the example, the feature vector 1000 is made up of sub-vectors 1005, 1010, 1015 and 1020 corresponding to four different regions 715, 710, 705 and 720 respectively of the source document 700. The feature vector 1000 then preferably undergoes a tfidf normalisation process in step 523. The normalisation process is described above with reference to the document classification method 300. Then, in step 524, the feature vector 1000 is evaluated by the field classifier SVM to provide a membership score for the corresponding candidate.

Other features such as layout, font style and size as well as linguistic and semantic features such as grammar structures and part-of-speech tags obtained by performing natural language processing on the text in each sub region can also be included in the feature vector.

Next, in step 525, the membership score is compared against a threshold value (typically 0.5). If the membership score exceeds the threshold (the YES option of step 525), then step 530 is followed where the current candidate is added to a list of matching candidates, and execution continues at step 535. If on the other hand, the test at step 525 reveals that the membership score is below or equal to the threshold (the NO option of step 525), then execution proceeds directly to step 535, by-passing step 530.

Step 535 checks whether all candidates have been processed. If NO, then execution returns to step 515 to select another candidate for processing, otherwise (the YES option of step 535) control flow proceeds to decision step 540. Step 540 determines if all text blocks have been processed and if not, method 500 returns to step 505 to select another text block for processing. If however decision step 540 determines that all text blocks have been processed then execution continues to step 545 where preferably the entry in the list of matches with the highest membership score is selected as the extracted data for the current field. Method 500 then terminates at step 550. If there are more fields in the form 225 to fill, the method 400 is repeated for the further fields.

In an alternative arrangement, a number of the highest scored entries in the list of matches are selected as possible extraction candidates and returned to the user for selection.

Training the Field Classifiers

Training of the field classifiers associated with each document category is preferably performed on a pool of training documents for the category, with the data to be extracted for each field preferably pre-identified. This is possible for example by monitoring and recording the action of an operator as she or he manually extracted text from documents and pasted the text into the corresponding forms. The pre-identified text for each field then constitutes a positive training candidate for the corresponding field classifier. Negative training candidates are preferably obtained by matching the FSM corresponding to each field against the document text. Each matching text apart from the pre-identified text (the positive training candidate) then constitutes a negative training candidate.

For each training candidate, the training document is partitioned into four regions (candidate, pre-sentence, pre-text and post-text) and a feature vector is constructed from the sub-feature vectors of the regions as described earlier. The feature vector then constitutes a positive training example for the field classifier if the training candidate is a positive training candidate, or a negative training example for a negative training candidate. By the above approach of selecting training candidates, the negative training examples are often more numerous than the positive training examples, but this is not of a concern for SVM based field classifiers.

### INDUSTRIAL APPLICABILITY

The arrangements described are applicable to the computer and data processing industries.

The foregoing describes only some embodiments of the present invention, and modifications and/or changes can be made thereto without departing from the scope and spirit of the invention, the embodiments being illustrative and not restrictive.

1. A method of learning associations between classes of documents and one or more structured data sets, said method comprising the steps of:
classifying a document into a class selected from a predefined set of classes;
displaying one or more structured data sets, wherein the displayed structured data sets are dependent on association information for the class;
receiving one or more indications of changes to the displayed structured data sets;
amending the association information for the class based on the received indications.

2. A method according to claim 1 wherein the association information comprises at least one query defining a structured data set.

3. A method according to claim 2 wherein the query comprises information extracted from the document.

4. A method according to claim 2 or 3 wherein the received indication results in a query being added to the association information for the class.

5. A method according to claim 2 or 3 wherein the received indication results in a query being modified in the association information for the class.

6. A method according to claim 2 or 3 wherein the received indication results in a query being deleted from the association information for the class.

7. A method according to claim 2 or 3 wherein the received indication results in a query being deleted from the association information for the class and wherein the query is deleted from the association information for the class if a predetermined number of indications to delete the query have been received.

8. A method according to any one of claims 1 to 3 wherein said classifying of the document is based on one or more information components extracted from the document.

9. A method according to any one of claims 1 to 3 wherein the document is classified into more than one class.

10. A method according to any one of claims 1 to 3 wherein said classification step comprises the steps of:
identifying one or more information components in the document;
calculating a membership score for the document in each class in the set of classes, based on the identified information components; and
classifying the document based on the membership scores.

11. A method according to any one of claims 1 to 3, wherein said classifying step is based on an analysis of previously classified documents.

12. A method according to claim 1 comprising the further step of:
extracting at least one item of information from a displayed data set for use in a task associated with the document.

13. A method according to any one of claims 1 to 3 further comprising the step of:
verifying information in the document using data in a displayed data set.

14. A method according to any one of claims 1 to 3 wherein the document is an unstructured document without a predefined format.

15. A method of extracting information for processing a document; the method comprising the steps of:
classifying the document into a class selected from a predefined set of classes, wherein said classifying is dependent on first information in the document;
identifying a data set based on second information in the document, wherein said identifying is dependent on association information adaptively obtained through processing other documents in the class;
extracting data from the document and the data set to process the document according to one or more tasks associated with the class.

16. A method of verifying information for processing a document, the method comprising the steps of:
classifying the document into a class selected from a predefined set of classes, wherein said classifying is dependent on first information in the document;
identifying a data set based on second information in the document, wherein said identifying is dependent on association information adaptively obtained through processing other documents in the class;
verifying information in the document using the identified data set;
extracting information from the document to process the document according to one or more tasks associated with the class.

17. An apparatus for learning associations between classes of documents and one or more structured data sets, said apparatus comprising:
means for classifying a document into a class selected from a predefined set of classes;
means for displaying one or more structured data sets, wherein the displayed structured data sets are dependent on association information for the class;
means for receiving one or more indications of changes to the displayed structured data sets; and
means for amending the association information for the class based on the received indications.

18. An apparatus for extracting information for processing a document, said apparatus comprising:
means for classifying the document into a class selected from a predefined set of classes, wherein said classifying is dependent on first information in the document;
means for identifying a data set based on second information in the document, wherein said identifying is dependent on association information adaptively obtained through processing other documents in the class;
means for extracting data from the document and the data set to process the document according to one or more tasks associated with the class.

19. An apparatus for verifying information for processing a document, the apparatus comprising:
means for classifying the document into a class selected from a predefined set of classes, wherein said classifying is dependent on first information in the document;
means for identifying a data set based on second information in the document, wherein said identifying is dependent on association information adaptively obtained through processing other documents in the class;
means for verifying information in the document using the identified data set;
means for extracting information from the document to process the document according to one or more tasks associated with the class.

20. A computer program product comprising machine-readable program code recorded on a machine-readable recording medium, for controlling the operation of a data processing apparatus on which the program code executes to perform a method of learning associations between classes of documents and one or more structured data sets, said method comprising the steps of:
classifying a document into a class selected from a predefined set of classes;
displaying one or more structured data sets, wherein the displayed structured data sets are dependent on association information for the class;
receiving one or more indications of changes to the displayed structured data sets; and
amending the association information for the class based on the received indications.

21. A computer program product comprising machine-readable program code recorded on a machine-readable recording medium, for controlling the operation of a data processing apparatus on which the program code executes to perform a method of extracting information for processing a document; the method comprising the steps of:
classifying the document into a class selected from a predefined set of classes, wherein said classifying is dependent on first information in the document;
identifying a data set based on second information in the document, wherein said identifying is dependent on association information adaptively obtained through processing other documents in the class;
extracting data from the document and the data set to process the document according to one or more tasks associated with the class.

22. A computer program product comprising machine-readable program code recorded on a machine-readable recording medium, for controlling the operation of a data processing apparatus on which the program code executes to perform a method of verifying information for processing a document, the method comprising the steps of:
classifying the document into a class selected from a predefined set of classes, wherein said classifying is dependent on first information in the document;
identifying a data set based on second information in the document, wherein said identifying is dependent on association information adaptively obtained through processing other documents in the class;
verifying information in the document using the identified data set;
extracting information from the document to process the document according to one or more tasks associated with the class.

23. A computer program comprising machine-readable program code for controlling the operation of a data processing apparatus on which the program executes to perform a method of learning associations between classes of documents and one or more structured data sets, said method comprising the steps of:
classifying a document into a class selected from a predefined set of classes;
displaying one or more structured data sets, wherein the displayed structured data sets are dependent on association information for the class;
receiving one or more indications of changes to the displayed structured data sets;
amending the association information for the class based on the received indications.

24. A computer program comprising machine-readable program code for controlling the operation of a data processing apparatus on which the program executes to perform a method of extracting information for processing a document; the method comprising the steps of:
classifying the document into a class selected from a predefined set of classes, wherein said classifying is dependent on first information in the document;
identifying a data set based on second information in the document, wherein said identifying is dependent on association information adaptively obtained through processing other documents in the class;
extracting data from the document and the data set to process the document according to one or more tasks associated with the class.

25. A computer program comprising machine-readable program code for controlling the operation of a data processing apparatus on which the program executes to perform a method of verifying information for processing a document, the method comprising the steps of:
classifying the document into a class selected from a predefined set of classes, wherein said classifying is dependent on first information in the document;
identifying a data set based on second information in the document, wherein said identifying is dependent on association information adaptively obtained through processing other documents in the class;
verifying information in the document using the identified data set;
extracting information from the document to process the document according to one or more tasks associated with the class.

26. A system for learning associations between classes of documents and one or more structured data sets, said system comprising:
data storage for storing at least one document, association information for a predefined set of classes of documents, and one or more databases; and
a processor in communication with the data storage and adapted to:
classify a document into a corresponding class selected from the predefined set of classes;
display one or more structured data sets derived from the one or more databases based on the association information for the corresponding class;
receive one or more indications of changes to the displayed structured data sets; and
amend the association information for the corresponding class based on the received indications.
